(19) United States
(12) Patent Application Publication
(10) Pub. No.: US 2008/0260583 A1
(43) Pub. Date: Oct. 23, 2008

(54) Micro-Fluidic Device Based Upon Active Matrix Principles

(75) Inventors: Mark Thomas Johnson, Eindhoven (NL); Marc Wilhelmus Gijsbert Ponjee, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/067,324

(22) PCT Filed: Sep. 13, 2006
(86) PCT No.: PCT/IB06/53256

§ 371 Date: Mar. 19, 2008

(30) Foreign Application Priority Data
Sep. 23, 2005 (EP) 05108796.3

(51) Int. Cl. B01J 19/00

(52) U.S. Cl. 422/68.1

(57) ABSTRACT

A micro-fluidic device (1) including a two-dimensional array of a plurality of components (2) for processing a fluid and/or for sensing properties of the fluid is suggested. Each component (2) is coupled to at least one control terminal (9,10) enabling an active matrix to change the state of each component individually. The active matrix includes a two-dimensional array of electronic components (12) realized in thin film technology. The active matrix provides a high versatility of the device. The thin film technology ensures a very cost efficient manufacturing also of large devices.

The present invention is related to a micro-fluidic device including a two-dimensional array of a plurality of components for processing a fluid and/or for sensing properties of the fluid.

Micro-fluidic devices are at the heart of most biochip technologies, being used for both the preparation of fluidic samples and their subsequent analysis. The samples may e.g. be blood based. As will be appreciated by those in the art, the sample solution may comprise any number of things, including, but not limited to, bodily fluids like blood, urine, serum, lymph, saliva, anal and vaginal secretions, perspiration and semen of virtually any organism: Mammalian samples are preferred and human samples are particularly preferred; environmental samples (e.g. air, agricultural, water and soil samples); biological warfare agent samples; research samples (i.e. in the case of nucleic acids, the sample may be the products of an amplification reaction, including both target an signal amplification); purified samples, such as purified genomic DNA, RNA, proteins etc.; unpurified samples and samples containing (parts of) cells, bacteria, viruses, parasites or funghi.

As it is well known in the art, virtually any experimental manipulation may have been done on the sample. In general, the terms “biochip” or “Lab-on-a-Chip” or alike, refer to systems, comprising at least one micro-fluidic component or biosensor, that regulate, transport, mix and store minute quantities of fluids rapidly and reliably to carry out desired physical, chemical and biochemical reactions in larger numbers. These devices offer the possibility of human health assessment, genetic screening and pathogen detection. In addition, these devices have many other applications for manipulation and/or analysis of non-biological samples. Biochip devices are already being used to carry out a sequence of tasks, e.g. cell lyses, material extraction, washing, sample amplification, analysis etc. They are progressively used to carry out several preparation and analysis tasks in parallel, e.g. detection of several bacterial diseases. As such, micro-fluidic devices and biochips already contain a multiplicity of components, the number of which will only increase as the devices become more effective and more versatile.

Many of the components are electrical components used to sense or modify a property of the sample or fluid, such as heating elements, pumping elements, valves etc., and are frequently realized by direct fabrication of thin film electronics on the substrate of the device. Suitable properties that can be sensed or modified include, but are not limited to, temperature; flow rate or velocity; pressure, fluid, sample or analyte presence or absence, concentration, amount, mobility, or distribution; an optical characteristic; a magnetic characteristic; an electrical characteristic; electric field strength, disposition, or polarity.

One problem of this approach is that every electrical component on the device requires control terminals to independently control the component. Consequently, more space is required to connect the components to the control devices than to realize the devices themselves. Ultimately, the number of control terminals will become so large that it will become impractical to arrange all the terminals at the periphery of the device to make electrical contact. One possibility to realize the electrical contact is the use of an electrical contact foil.

In order to avoid a large number of control terminals, U.S. Pat. No. 6,852,287 proposes embodiments of a method to control a number N of independently controllable components with smaller number of control terminals. In order to achieve this, both the use of multiplexing techniques or passive matrix techniques is proposed. In particular, the matrix technique is extremely attractive, as this allows for the maximum number of components to be controlled with the minimum number of control terminals. Conceptually, if one specific heater element is activated also a number of other heater elements will be activated unintentionally. As a result, heat will be generated where it is not required, and the heat generated at the intended heater element will be different than required as either some of the applied current has traveled through alternative paths, or the applied voltage is dropped along the rows and columns before reaching the heater element intended to be activated.

It is an object of the invention to provide a micro-fluidic device having an improved performance compared to passive matrix based devices. This object is achieved by a micro-fluidic device, e.g. a biochip, fabricated on a substrate based upon active matrix principles. The device is preferably fabricated from one of the well known large area electronics technologies, such as a-Si, LTPS or organic transistor technologies. The active matrix makes it possible to independently control a larger number of components on the device with a smaller number of control terminals.

The present invention describes a micro-fluidic device including a two-dimensional array of a plurality of components for processing a fluid and/or for sensing properties of the fluid. Each component is coupled to at least one control terminal enabling an active matrix to change the state of each component individually. The active matrix includes a two-dimensional array of electronic components realized in thin film technology. The active matrix provides a high versatility of the device. The thin film technology ensures a very cost efficient manufacturing also of large devices.

In one advantageous embodiment of the invention the electronic components of the active matrix are formed by thin film transistors having gate, source and drain electrodes. In this case the active matrix includes a set of select lines and a set of control lines such that each individual component is controlled by one select line and one control line and the gate electrode of each thin film transistor is connected to a select line.

In another advantageous embodiment of the invention a memory device is provided for storing a control signal supplied to the control terminal.

In an alternative embodiment of the invention the electronic components are formed by thin film diodes, e.g. metal-insulator-metal (MIM) diodes. It is preferred that a MIM diode connects a first electrode of each component to a control line, and a second electrode of each component is connected to a select line.

In another advantageous embodiment of the invention the thin film diodes are PIN or Schottky diodes, wherein a first diode connects a first electrode of each component to a control line, wherein a second diode connects the first electrode of each component to a common rest line and wherein a second electrode of each component is connected to a select line.

In an advantageous development of the invention the first diode is replaced by a pair of diodes connected in parallel and the second diode as well is replaced by a pair of diodes connected in parallel.

In yet another advantageous development the first diode is replaced by a pair of diodes connected in series, and also the second diode is replaced by a pair of diodes connected in series.

The invention will be better understood and other particular features and advantages will become apparent on reading the following description appended with drawings. In the drawings:

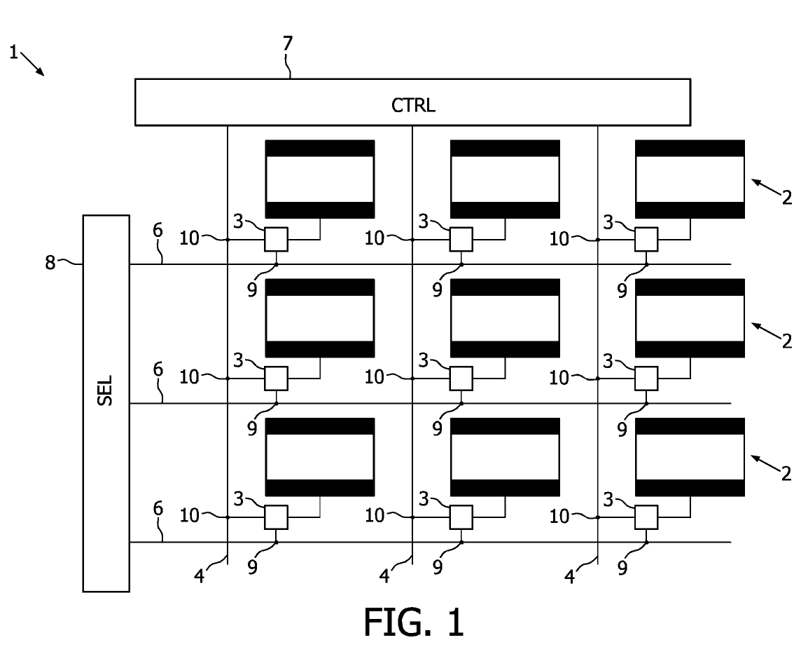

FIG. 1 a schematic block diagram of a micro-fluidic device according to the invention illustrating the active matrix concept;

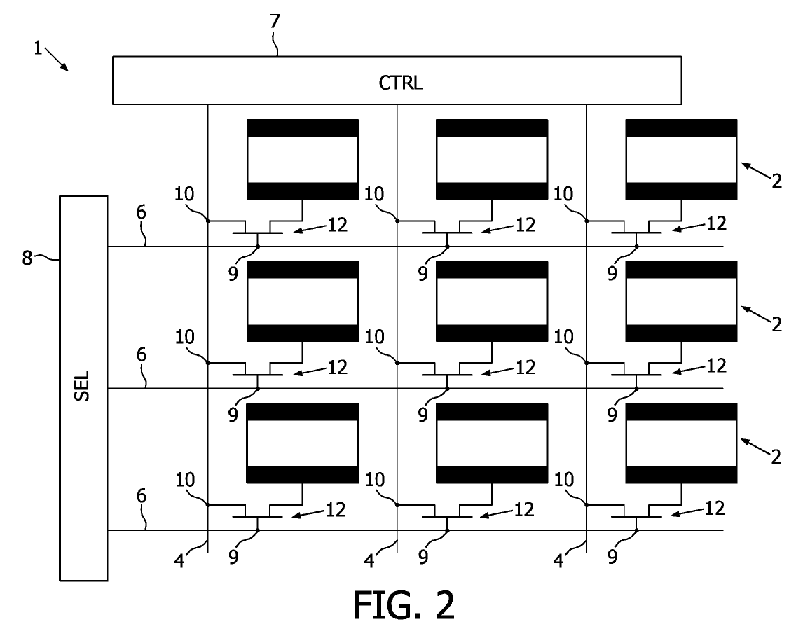

FIG. 2 a first embodiment of the micro-fluidic device, the active matrix of which is based on thin film transistors;

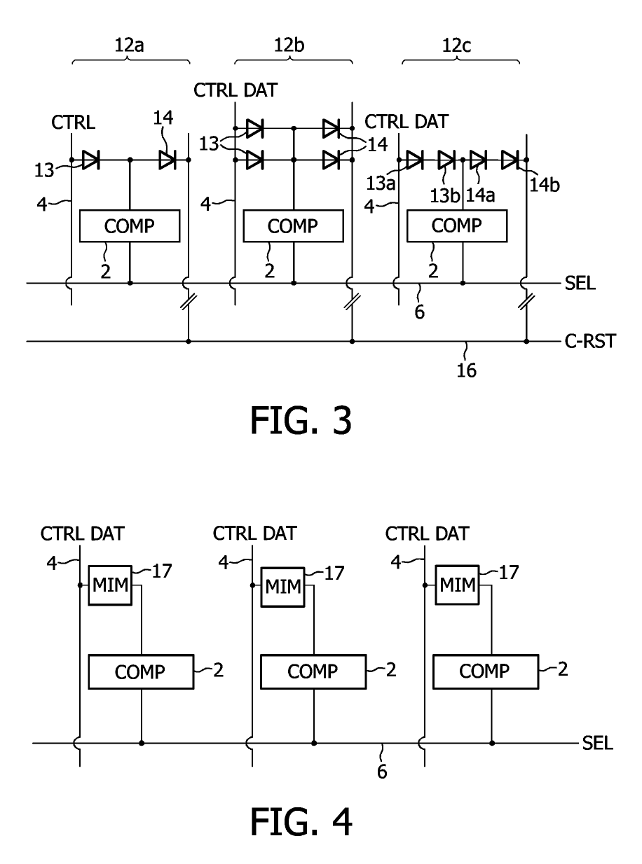

FIG. 3 a second embodiment of the micro-fluidic device, the active matrix of which is based on semiconductor diodes; and

FIG. 4 a third embodiment of the micro-fluidic device, the active matrix of which is based on metal-insulator-metal diodes.

FIG. 1 illustrates the general concept of a micro-fluidic device based on an active matrix. The micro-fluidic device as a whole is designated with the reference number 1. The device comprises a two-dimensional array of components 2. Each component 2 is associated with a switching means 3 arranged to selectively activate the component 2. Each switching means is connected to a control line 4 and a select line 6. The control lines 4 are connected to a common control driver 7. The select lines 6 are connected to a common select driver 8. The control lines 4 in conjunction with the select lines 6 form a two-dimensional array of control terminals 9, 10.

In this way an active matrix is realized to ensure that all components can be driven independently. The component 2 may be any electronic device e.g. a heater element, a pumping element, a valve, a sensing component etc. being driven by either a voltage or a current signal. It is to be understood that the examples for the components 2 are not to be construed in a limiting sense. Activating a component 2 means changing its state e.g. by turning it from on to off, or vice versa or by changing its setting. It is also noted that the individual switching means 3 may comprise a plurality of sub components comprising both active and/or passive electronic components. However, there is no requirement that all sub components are activated together.

The operation of the micro-fluidic device 1 illustrated in FIG. 1 to independently control a single component 2 is as follows:
In the non-addressing state, all select lines 6 are set to a voltage where the switching elements 3 are non-conducting. In this case, no component 2 is activated.
In order to activate a preselected component 2 the select driver 8 applies a select signal to the select line 6 to which the preselected component 2 is coupled. As a consequence all switching means 3 connected to the same select line 6 are switched into a conducting state.
A control signal generated by the control driver 7, e.g. a voltage or a current is applied to the control line where the preselected component 2 is situated. The control signal is set to its desired level and is passed through the switching means 3 to the component 2, causing the component to be activated.
The control signals in all other control lines 4 are held at a level, which will not change the state of the remaining components connected to the same select line 6 as the preselected component 2. In this example, they will remain un-activated.
All other select lines 6 will be held in the non-select state, so that the other components 2 connected to the same control line 4 as the preselected component will not be activated because their associated switching means 3 remain in a non-conducting state.
After the preselected component is set into the desired state, the respective select line 6 is unselected, returning all switching means 3 into a non-conducting state, preventing any further change in the state of the preselected component.

The device will then remain in the non-addressed state until the following control signal requires to change the state of any one of the components 2, at which point the above sequence of operation is repeated.

The two-dimensional array formed by the control lines 4 and the select lines 6 can also be described in terms of rows and columns, where the select lines 6 define the rows and the control lines 4 the columns.

It is also possible to control more than one component 2 in a given row simultaneously by applying a control signal to more than one column in the array during the select period. It is possible to sequentially control components in different rows by activating another row by using the select driver and applying a control signal to one or more columns in the array.

It is also possible to address the micro-fluidic device 1 such that a component 2 is only activated while the control signal is present. However, in a preferred embodiment, it is advantageous to incorporate a memory device into the component whereby the control signal is remembered after the select period is completed. For the memory device a capacitor or a transistor based memory element is suitable. This makes it possible to have a multiplicity of components at any point across the array activated simultaneously. This option is not available in the passive system known in the prior art. Of course, if a memory device is available, a second control signal will explicitly be required to de-activate the component.

After having illustrated the general concept and the advantages of a micro-fluidic device 1 in the following description three specific embodiments will be explained.

### EMBODIMENT 1

### Active Matrix Micro-Fluid Device Based on Thin Film Transistors

FIG. 2 exhibits an active matrix micro-fluidic device 1 using thin film transistors (TFT) 12 as switching means 3 to ensure that all components can independently be activated. Each component 2 is connected to the matrix of control terminals via a TFT switch 12. TFTs are well known switching elements in thin film large area electronics, and have found extensive use e.g. in flat panel display applications. Industrially, the major manufacturing methods for TFTs are based upon either amorphous-silicon (a-Si) or low temperature polycrystalline silicon (LTPS) technologies. But other technologies such as organic semiconductors or other non-Si based semiconductor technologies, such as CdSe, can be used. The operation of the device illustrated in FIG. 2 to independently control a single component 2 is as follows:
In the non-addressing state, all select lines 6 are set to a voltage where the TFTs are non-conducting. In the case of a-Si, we have typically an n-type TFT and hence a negative voltage has to be applied to the gate of the TFTs. In this case, no component 2 is activated.
In order to activate a preselected component 2 the select driver 8 applies a positive select signal to the select line 6 to which the preselected component 2 is connected. Thus, all TFTs 12 connected to this select line are switched into their conducting state.
A control signal generated by the control driver 7, a voltage or current signal is applied to the column where the preselected component is located. The TFT 12 passes the control signal to the preselected component, which is coupled to the drain of the TFT, for activating the component.
The control signals in all other columns are held at a level that will not change the state of remaining components of the row. In this example, they will remain un-activated.
The select signals of all other rows will be held in the non-select state by applying a negative voltage signal to the gate of the TFTs, so that the other components are connected to the same column via non-conducting TFTs and will not be activated.
After the component is set into the desired state, the TFTs 12 in the row are again set to the non-conducting state, preventing any further change in the state of the component.

The device will then remain in the non-addressed state until the following control signal requires to change the state of any one of the components, at which point the above sequence of operation is repeated.

With a TFT based switch, it is again possible to control more than one component in a given row simultaneously by applying a control signal to more than one column in the array during the select period. It is possible to sequentially control components in different rows by activating another row by using the select driver and by applying a control signal to one or more columns in the array. Furthermore, it is still possible to address the system such that the component is only activated while the control signal is present, or alternatively to incorporate a memory device into the component (e.g. a capacitor element, or a transistor based memory element) whereby the control signal is remembered after the select period is completed.

### EMBODIMENT 2

### Active Matrix Micro-Fluid Device Based on Diodes

FIG. 3 displays a portion of a micro-fluidic device 1 having an active matrix based on thin film diode technology. Though offering somewhat less flexibility, an active matrix based on thin film diodes is technologically less demanding and may therefore be advantageous in certain applications. Diode active matrix arrays have been used for e.g. active matrix LCDs and can be driven in several known ways, one of which is the double diode with reset (D2R) approach. This approach has been suggested by K. E. Kuijk in Proceedings of the 10^{th} International Display Research Conference (1990, Amsterdam), page 174.

In particular, FIG. 3 shows three types of pixel circuits 12a, 12b, 12c of this active matrix array side by side. In most cases only one type of these pixel circuits will be present on a specific micro-fluidic device. However, processing technology allows to have different types of pixel circuits on a single micro-fluidic device. The different pixel circuits will be discussed in the following from the left hand side to the right hand side in FIG. 3. In the first pixel circuit 12a, a diode 13 provides a control signal to the component 2 via the control line 4. A diode 14 removes the control signal from the component 2 via a common reset line C-RST 16. The blocking range, i.e. the voltage range where the diodes are non-conducting, is determined by the external voltages and therefore adjustable. This is a major advantage where higher operating voltage components are required.

In the second pixel circuit 12b each diode 13, 14 is replaced by a pair of diodes connected in parallel thus increasing the current carrying capacity of the pixel circuit 12b compared to the pixel circuit 12a.

Similarly, higher voltages can easily be accommodated by providing diodes in series as this prevents breakdown of separate diodes at high reverse voltage because the voltage is split across the diodes. The pixel circuit 12c shown on the right hand side of FIG. 3 exemplifies this configuration. The pixel circuit 12c incorporates a series connection of two diodes 13a, 13b for supplying the control signal, as well as a series connection of two diodes 14a, 14b for removing the control signal.

The number of external connections is equal to the number of rows plus columns plus one, which is the common reset line 16. The circuit is very independent of the diode characteristics, and PIN (p-type, intrinsic, n-type) or Schottky diodes can be chosen. The circuit can be made redundant for short or open circuit errors by using extra diodes in series or parallel. The rows are driven using a reset method with five voltage levels according to the method suggested by K. E. Kuijk already mentioned above.

A PIN (or Schottky—IN) diode can be formed using a simple 3-layer process. An amorphous semiconductor layer, a stack of p-doped, intrinsic, and n-doped regions, is sandwiched between top an bottom metal lines, which are oriented perpendicular. The electrical properties are hardly alignment sensitive.

### EMBODIMENT 3

### Active Matrix-Fluid Device Based on MIM Diodes

Similar to the thin film diode technology, an active matrix using metal-insulator-metal (MIM) diode technology for making an active matrix is technologically less demanding than using TFTs at the expense of a somewhat reduced flexibility.

Traditionally, MIM diode active matrix arrays, as used for active matrix LCDs, have a layout similar to the passive matrix as discussed in U.S. Pat. No. 6,852,287. However, a MIM diode is introduced as a non-linear resistance element in series with each component, to allow for active matrix addressing as it is shown in FIG. 4.

The MIM device is created by separating 2 metal layers by a thin insulating layer and structure and is conveniently realized in the form of a cross over structure. Examples are hydrogenated silicon nitride sandwiches between Cr of Mo metals as suggest by A. G. Knapp an R. A. Hartmann in Proceeding of the 14^{th} International Display Research Conference (1994), page 14. A second example is Ta₂O₅ insulator sandwiched between Ta metal electrodes.

In the micro-fluidic device schematically shown in FIG. 4 a MIM diode 17 connects a first electrode of the component 2 to the control line 4. Both metal layers and also the insulating layer are realized on the same substrate. The component connections can be completed by adding a second electrode to the first substrate and separating it with a further and thicker insulating layer as a crossover. In an alternative embodiment of the MIM diode active matrix the MIM diode 17 connects the first electrode of the component 2 to the select line 6 while the second electrode of the component 2 in connected to the control line 4. The operation of a MIM active matrix has also been described by A. G. Knapp und R. A. Hartmann already cited above. The second electrode provides a conductive connection to the select line 6.

1. Micro-fluidic device (1) comprising a two-dimensional array of a plurality of components (2) for processing a fluid and/or for sensing properties of the fluid, wherein each component (2) is coupled to at least one control terminal (9, 10) enabling an active matrix to change the state of each component individually, and wherein the active matrix includes a two-dimensional array of electronic components (12, 13, 13a, 13b, 14, 17) realized in thin film technology.

2. Micro-fluidic device (1) according to claim 1, characterized in that the electronic components of the active matrix are formed by thin film transistors (12) having gate, source and drain electrodes.

3. Micro-fluidic device (1) according to claim 2, characterized in that the active matrix includes a set of select lines (6) and a set of control lines (4) such that each individual component (2) is controlled by one select line (6) and one control line (4) and in that the gate electrode of each thin film transistor is connected to a select line (6).

4. Micro-fluidic device (1) according to claim 1, characterized in that a memory device is provided for storing a control signal supplied to the control terminal (9, 10).

5. Micro-fluidic device (1) device according to claim 1, characterized in that the electronic components are formed by thin film diodes (13, 13a, 13b, 17).

6. Micro-fluidic device (1) according to claim 5, characterized in that the thin film diodes are metal-insulator-metal (MIM) diodes (17).

7. Micro-fluidic device (1) according to claim 6, characterized in that a MIM diode (17) connects a first electrode of each component (2) to a control line (4), and that a second electrode of each component (2) is connected to a select line (6).

8. Micro-fluidic device (1) according to claim 5, characterized in that the thin film diodes are PIN or Schottky diodes (13, 13a, 13b, 14, 14a, 14b), that a first diode (13, 13a, 13b) connects a first electrode of each component (2) to a control line (4) that a second diode (14) connects the first electrode of each component (2) to a common reset line (16) and that a second electrode of each component (2) is connected to a select line (6).

9. Micro-fluidic device (1) according to claim 8, characterized in that the first diode (13) is a pair of diodes connected in parallel and that the second diode (14) is a pair of diodes connected in parallel.

10. Micro-fluidic device (1) according to claim 8, characterized in that the first diode (13) is a pair of diodes (13a, 13b) connected in series, and that the second diode (14) is a pair of diodes (14a, 14b) connected in series.
